(19) United States
(12) Patent Application Publication
(10) Pub. No.: US 2017/0159613 A1
(43) Pub. Date: Jun. 8, 2017

(54) METHOD OF OPERATING AN AUTOMOTIVE SYSTEM FOR POWERING A VEHICLE

(71) Applicant: GM GLOBAL TECHNOLOGY OPERATIONS LLC, Detroit, MI (US)

(72) Inventor: Davide DI NUNNO, Torino (IT)

(73) Assignee: GM GLOBAL TECHNOLOGY OPERATIONS LLC, Detroit, MI (US)

(21) Appl. No.: 15/373,295

(22) Filed: Dec. 8, 2016

(30) Foreign Application Priority Data
Dec. 8, 2015 (GB) 1521618.7

(51) Int. Cl. F02M 23/06; F02D 21/10; F02D 13/02; F02D 41/12

(52) U.S. Cl. CPC F02M 23/067; F02D 41/12; F02D 21/10; F02D 13/0246

(57) ABSTRACT

A method and system for operating an automotive system with regenerative power is disclosed. The automotive system includes an internal combustion engine including at least one cylinder having exhaust valves. When a deceleration of the vehicle is detected, the exhaust valves are activated to direct compressed air from the cylinder into a high pressure tank fluidically connected to the cylinder.

### CROSS-REFERENCE TO RELATED APPLICATION

This application claims priority to Great Britain Patent Application No. 1521618.7, filed Dec. 8, 2015, which is incorporated herein by reference in its entirety.

### TECHNICAL FIELD

The present disclosure pertains to a method of operating an automotive system for powering a vehicle.

### BACKGROUND

Several known methods have been implemented to reduce CO₂ emission by internal combustion engines of automotive systems such as energy recovering during braking of the vehicle. Energy recovery methods have been applied to traditional internal combustion engines (ICEs) as well as other type of engines.

One of the most convenient methods to recover braking energy is using an electric machine. During accelerations of the vehicle, power is supplied by the internal combustion engine (ICE) and, during braking of the vehicle, the electric machine brakes the vehicle, converting kinetic energy of the vehicle into electrical energy that is to be stored in batteries onboard of the vehicle. Such electrical energy can be used later, for example, by the same electrical machine acting as a motor or can be destined to other uses.

Other version of hybrid vehicles use compressed air pumps during energy recovery which can be also be used as pneumatic motors during accelerations. Other known ways of energy recovery are of mechanical type, using, for example, a flywheel rotating at high speed.

All the above methods need to couple two different types of machines in order to be performed, namely an ICE and an electric machine or an ICE and a pneumatic machine or an ICE and a flywheel, leading to high costs of the overall system.

Accordingly there is a need to implement energy recovery during braking of the vehicle without the need of using two different machines.

### SUMMARY

An embodiment of the disclosure provides a method of operating an automotive system for powering a vehicle. The automotive system includes an internal combustion engine equipped with at least one cylinder having exhaust valves. When a deceleration of the vehicle is detected, an exhaust valve of at least one cylinder is activated to direct compressed air into a high pressure tank fluidically connected to the cylinder. An advantage of this embodiment is that stores energy deriving from the braking of the vehicle in the form of pressure of the compressed air in a dedicated high pressure tank.

According to another embodiment, the method further includes detecting a torque request and directing compressed air from the high pressure tank into the cylinder. An advantage of this embodiment is that it recovers the energy stored in the form of pressure of the compressed air in the high pressure tank to power the vehicle.

According to another embodiment, the compressed air from the high pressure tank is directed from the high pressure tank into an air intake duct flowing into an intake manifold of the internal combustion engine. An advantage of this embodiment is that it uses existing conduits to recover the energy stored in the high pressure tank.

According to another embodiment, the compressed air from the high pressure tank is directed into the cylinder bypassing an air intake duct of the internal combustion engine. An advantage of this embodiment is that it avoids turbo VGT backpressure which causes pumping losses by using a dedicated branch of a compressed air circuit to route compressed air under pressure into the cylinder.

According to another embodiment, the compressed air from the high pressure tank is directed into the cylinder, if the compressed air pressure inside the high pressure tank is greater than a threshold pressure thereof. An advantage of this embodiment is that it uses compressed air having a suitable pressure to power the vehicle.

According to still another embodiment, fuel injection into the cylinder is interrupted when compressed air is directed from the cylinder into the high pressure tank. According to a further embodiment, fuel injection into the cylinder is interrupted when compressed air is directed from the high pressure tank into the cylinder. Both these two embodiments have the advantage of saving fuel.

Another aspect of the present disclosure provides an apparatus for operating an automotive system including an internal combustion engine equipped with cylinders having exhaust valves. The apparatus is configured to detect a deceleration of the vehicle, and activate an exhaust valve associated with at least one cylinder to direct compressed air into a high pressure tank fluidically connected to the cylinder. This aspect has similar effects with respect to the previous embodiment, namely it stores energy deriving from the braking of the vehicle in the form of pressure of the compressed air in a dedicated high pressure tank.

According to an aspect of the present disclosure, the apparatus is configured to activate an exhaust valve of the cylinder include a sliding cam mechanization system. An advantage of this aspect is that it controls the closure of the exhaust valve in a load step fashion.

According to an aspect of the present disclosure, the apparatus is configured to activate an exhaust valve of the cylinder include a continuous Variable Valve Actuation (VVA) system. An advantage of this aspect is that it controls the closure of the exhaust valve in a continuous fashion due to the fact that such system may be mechanized with the use of a cam phaser.

According to another aspect of the present disclosure, the apparatus includes a branch of a pressurized air circuit connecting an outlet of the high pressure tank to an intake valve of the cylinder. An advantage of this aspect is that it avoids turbo VGT backpressure which causes pumping losses by using a dedicated branch of a compressed air circuit to route compressed air under pressure into the cylinder.

According to another aspect, an internal combustion engine is equipped with at least one cylinder having an exhaust valve fluidically connected with an inlet of a high pressure tank. An advantage of this aspect is that it stores energy deriving from the braking of the vehicle in the form of pressure of the compressed air in a dedicated high pressure tank.

According to still another aspect, the high pressure tank is fluidically connected to an air intake duct flowing into an intake manifold of the internal combustion engine. An advantage of this aspect is that it uses existing conduits to recover the energy stored in the high pressure tank.

According to still another aspect, the high pressure tank is fluidically connected to an inlet valve of the engine. An advantage of this aspect is that it avoids turbo VGT backpressure which causes pumping losses by using a dedicated branch of a compressed air circuit to route compressed air under pressure into the cylinder.

### BRIEF DESCRIPTION OF THE DRAWINGS

The present disclosure will hereinafter be described in conjunction with the following drawing figures, wherein like numerals denote like elements.

FIG. 1 shows an automotive system;

FIG. 2 is a cross-section of an internal combustion engine belonging to the automotive system of FIG. 1;

FIG. 3 shows a portion of the automotive system of FIG. 1 depicting a first mode of operation of an embodiment of the present disclosure;

FIG. 4 shows another mode of operation of the embodiment of FIG. 3;

FIG. 5 shows a first mode of operation of another embodiment of the present disclosure;

FIG. 6 shows a second mode of operation of the embodiment of FIG. 5;

FIG. 7 shows another mode of operation of the embodiment of FIG. 5; and

FIG. 8 is a flowchart representing an embodiment of the present disclosure.

### DETAILED DESCRIPTION

The following detailed description is merely exemplary in nature and is not intended to limit the invention or the application and uses of the invention. Furthermore, there is no intention to be bound by any theory presented in the preceding background of the invention or the following detailed description.

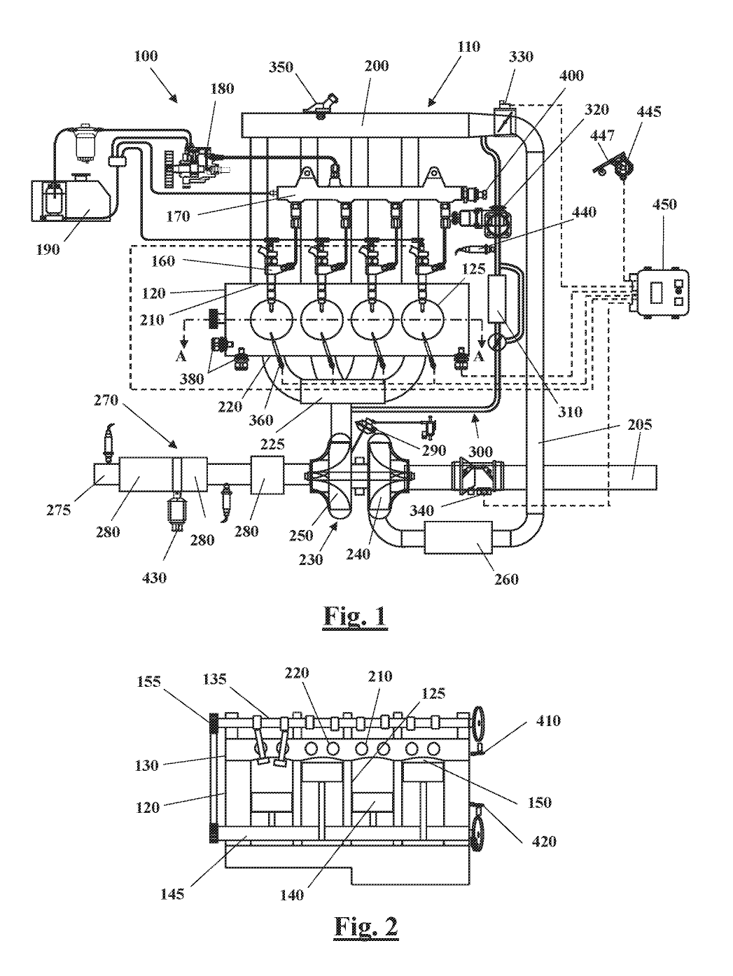

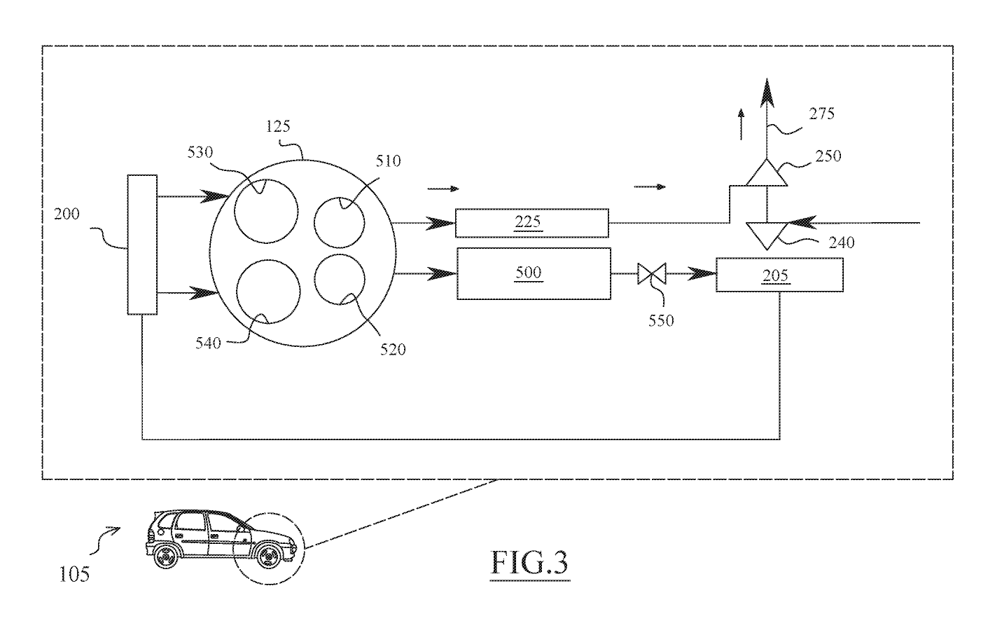

Some embodiments may include an automotive system 100 for powering an automotive vehicle 105, as shown in FIGS. 1 and 2, that includes an internal combustion engine (ICE) 110 having an engine block 120 defining at least one cylinder 125 having a piston 140 coupled to rotate a crankshaft 145. A cylinder head 130 cooperates with the piston 140 to define a combustion chamber 150. A fuel and air mixture (not shown) is disposed in the combustion chamber 150 and ignited, resulting in hot expanding exhaust gasses causing reciprocal movement of the piston 140. The fuel is provided by at least one fuel injector 160 and the air through at least one intake port 210. The fuel is provided at high pressure to the fuel injector 160 from a fuel rail 170 in fluid communication with a high pressure fuel pump 180 that increases the pressure of the fuel received from a fuel source 190. Each of the cylinders 125 has at least two valves, actuated by a camshaft 135 rotating in time with the crankshaft 145. The valves selectively allow air into the combustion chamber 150 from the port 210 and alternately allow exhaust gases to exit through a port 220. In some examples, a cam phaser 155 may selectively vary the timing between the camshaft 135 and the crankshaft 145.

In some embodiments of the present disclosure, as represented in FIGS. 3-7, the cylinder 125 may be provided with a first intake valve 530 and a second intake valve 540 and with a first exhaust valve 510 and a second exhaust valve 520. The air may be distributed to the air intake port(s) 210 through an intake manifold 200. An air intake duct 205 may provide air from the ambient environment to the intake manifold 200. In other embodiments, a throttle body 330 may be provided to regulate the flow of air into the manifold 200.

In still other embodiments, a forced air system such as a turbocharger 230, having a compressor 240 rotationally coupled to a turbine 250, may be provided. Rotation of the compressor 240 increases the pressure and temperature of the air in the duct 205 and manifold 200. A charge air cooler 260 disposed in the duct 205 may reduce the temperature of the air. The turbine 250 rotates by receiving exhaust gases from an exhaust manifold 225 that directs exhaust gases from the exhaust ports 220 and through a series of vanes prior to expansion through the turbine 250. The exhaust gases exit the turbine 250 and are directed into an exhaust system 270. This example shows a variable geometry turbine (VGT) with a VGT actuator 290 arranged to move a rack of vanes 295 in different positions, namely from a fully closed position to a fully open position, to alter the flow of the exhaust gases through the turbine 250. In other embodiments, the turbocharger 230 may be fixed geometry and/or include a waste gate.

The exhaust gases of the engine are directed into an exhaust system 270. The exhaust system 270 may include an exhaust pipe 275 having one or more exhaust aftertreatment devices 280. The aftertreatment devices may be any device configured to change the composition of the exhaust gases. Some examples of aftertreatment devices 280 include, but are not limited to, catalytic converters (two and three way), oxidation catalysts, lean NOₓ traps, hydrocarbon adsorbers, selective catalytic reduction (SCR) systems, and particulate filters.

Other embodiments may include an exhaust gas recirculation (EGR) system 300 coupled between the exhaust manifold 225 and the intake manifold 200. The EGR system 300 may include an EGR cooler 310 to reduce the temperature of the exhaust gases in the EGR system 300. An EGR valve 320 regulates a flow of exhaust gases in the EGR system 300.

The automotive system 100 may further include an electronic control unit (ECU) 450 in communication with one or more sensors and/or devices associated with the ICE 110 and with a memory system, or data carrier 460, and an interface bus. The ECU 450 may receive input signals from various sensors configured to generate the signals in proportion to various physical parameters associated with the ICE 110. The sensors include, but are not limited to, a mass airflow and temperature sensor 340, a manifold pressure and temperature sensor 350, a combustion pressure sensor that may be integral within glow plugs, coolant and oil temperature and level sensors 380, a fuel rail pressure sensor 400, a cam position sensor 410, a crank position sensor 420, exhaust pressure and temperature sensors 430, an EGR temperature sensor 440, and an accelerator pedal 447 position sensor 445. Furthermore, the ECU 450 may generate output signals to various control devices that are arranged to control the operation of the ICE 110, including, but not limited to, the fuel injectors 160, the throttle body 330, the EGR Valve 320, a Variable Geometry Turbine (VGT) actuator 290, and the cam phaser 155. Note, dashed lines are used to indicate communication between the ECU 450 and the various sensors and devices, but some are omitted for clarity.

FIG. 3 shows a portion of the automotive system 100 of FIG. 1, wherein a cylinder 125 of the engine 110 is represented, the cylinder being provided with a first intake valve 530 and a second intake valve 540 and with a first exhaust valve 510 and a second exhaust valve 520. The first exhaust valve 510 is fluidically connected with the exhaust manifold 225 and the second exhaust valve 520 is fluidically connected with an inlet 505 of a high pressure tank 500 by means of a connecting branch 515.

An outlet 507 of the high pressure tank 500 is, in turn, connected into the air intake duct 205 that flows into the intake manifold 200 of the internal combustion engine 110. A valve 550 is provided to regulate flow of compressed air from the high pressure tank 500 towards the air intake duct 205. In this way, compressed air stored into the high pressure tank 500 can be recirculated back into the cylinder 125 of the engine 110 through one of the intake valves 530, 540, for example through second intake valve 540.

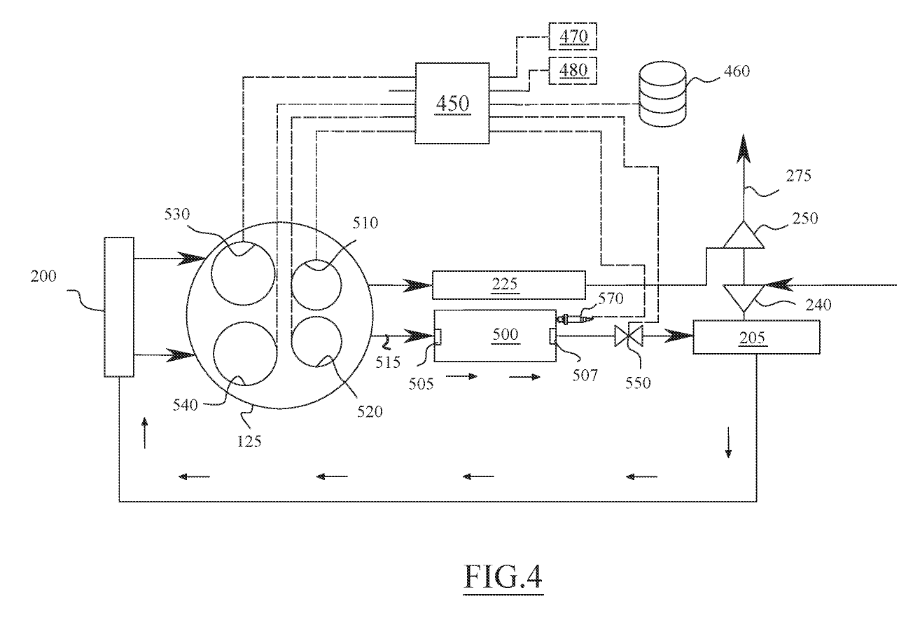

During accelerations, the engine 110 supplies energy to the vehicle 105 and first exhaust valve 510 is activated to let exhaust gas to be expelled into the exhaust manifold 225 of the engine 110, according to a customary way of operating an internal combustion engine 110, while second exhaust valve 520 remains closed. However, as depicted in FIG. 4, during decelerations of the vehicle 105, first exhaust valve 510 remains closed and second exhaust valve 520 is activated to let compressed air flow into high pressure tank 500. As explained hereinafter, activation of the second exhaust valve 520 can be performed using a variable valve actuation system (VVA). With the term activation referred to the exhaust valves 510,520 of the cylinder it is intended a controlled opening of such valves in order to optimize the accumulation of compressed air into the high pressure tank 500.

Compressed air pressure in the high pressure tank 500 is therefore raised and, when the pressure reaches a predetermined threshold, for example measured by pressure sensor 570 or by other means, valve 550 is activated and compressed air flows into the air intake duct 205 then into the intake manifold 200 and, finally, through activation of second intake valve 540 into the cylinder 125.

Also, with the term activation referred to the intake valves 530,540 of the cylinder it is intended a controlled opening of such valves in order to optimize the flow of compressed air into the cylinder 125. Therefore, in this phase, cylinder 125 operates as a pneumatic motor supplying power to the vehicle 105 by exploiting the fact that the structures of a piston engine and of a piston compressor are very similar and, according to an embodiment of the present disclosure, the engine 110 is used a compressor during the decelerations of the vehicles to store energy in the high pressure tank 500 in the form of compressed air.

In this way, the internal combustion engine 110 may be operated either in an ICE configuration or in an Energy Recovery mode, as summarized in the following Table 1:

TABLE 1

| ICE Configuration | Energy Recovery |
|---|---|
| first exhaust valve 510 active | first exhaust valve 510 closed |
| second exhaust valve 520 closed | second exhaust valve 520 active |

According to an embodiment of the present disclosure, a variable valve actuation system (VVA) may be used to operate first intake valves 530,540 and activate first and second exhaust valves 510, 520. In particular, the Variable Valve Actuation (VVA) technology commands the exhaust valves with different lifts depending on the fact that the cylinder is operating conventionally or as a pneumatic motor.

As it is known, several valve control technologies have been developed; one of these is Variable Valve Actuation (VVA), in terms of valve timing or lift, adopting optimized cam lobe profiles for intake and/or exhaust valves. More in particular, several known VVA technologies can be used to implement the various embodiments of the present disclosure.

By way of example, with no limiting purposes, a first technology that can be used is a sliding cam mechanization system 470 where two or more cam profiles are used in combination with an actuator used to swap between the profiles, depending on various conditions such as engine speed or engine load. Cam switching provides a discrete or step load variation of valve lift profile.

An alternative technology is the use of a continuous Variable Valve Actuation system. Such system may be mechanized with the use of a cam phaser 480, namely a device equipped with two concentric shafts, an external shaft supporting the cams and an eccentric internal shaft used to vary the position of the cams, the cam phaser device 480 being able to provide a continuous variation of valve lift profile. In any case, each of the VVA systems that may be used is controlled by an Electronic Control Unit 450 of the engine 110.

According to an embodiment of the method, in order to save fuel, fuel injection into the cylinder is interrupted when compressed air is directed from the cylinder 125 into the high pressure tank 500. Also, fuel injection into the cylinder is interrupted when compressed air is directed from the high pressure tank 500 into the cylinder 125.

According to still another embodiment of the method, a step of mixing compressed air deriving from the high pressure tank 500 with fuel injected into the cylinder 125 can be performed. In case of internal combustion engines in which fuel is injected into the intake manifold 200 compressed air deriving from the high pressure tank 500 can be mixed with such injected fuel.

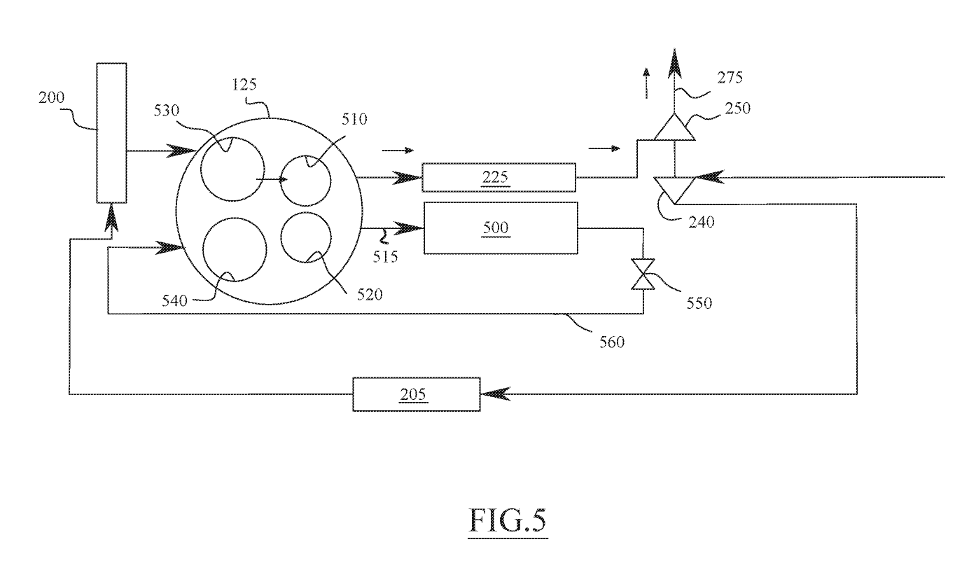

FIGS. 5-7 show various modes of operation of another embodiment of the present disclosure.

FIG. 5 shows a first mode of operation of another embodiment of the present disclosure. In the embodiment of FIG. 5, the second exhaust valve 520 is connected to a dedicated branch 560 of a pressurized air circuit by interposition of valve 550. During accelerations, as in the embodiment of FIG. 3, the engine 110 supplies energy to the vehicle 105 and first exhaust valve 510 is activated to let exhaust gas to be expelled into the exhaust manifold 225 of the engine 110, according to a customary way of operating an internal combustion engine 110, while second exhaust valve 520 remains closed. Internally to the cylinder 125, exhaust gas flows from first intake valve 530 to first exhaust valve 510.

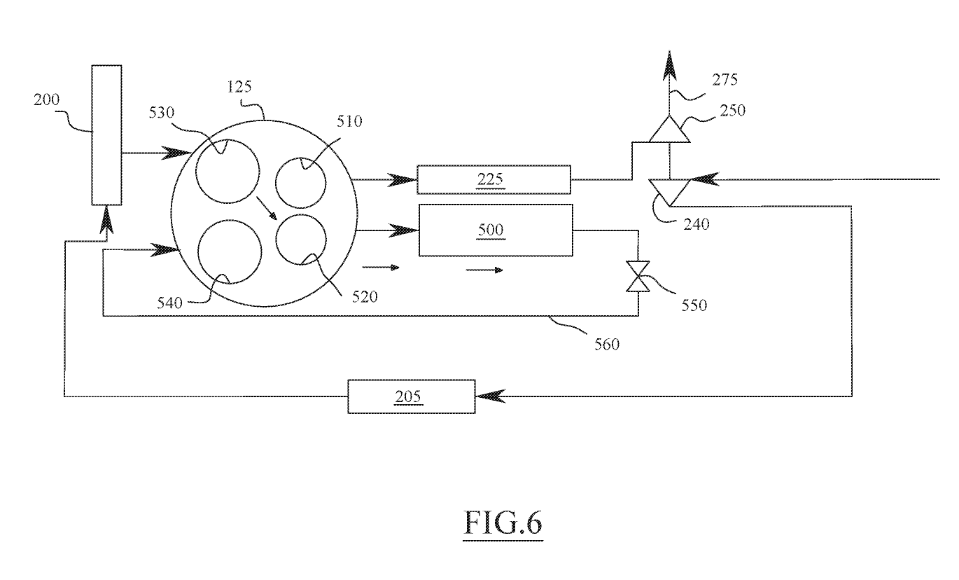

As depicted in FIG. 6 however, in a second mode of operation, during decelerations of the vehicle 105, first exhaust valve 510 remains closed and second exhaust valve 520 is activated to let compressed air flow into high pressure tank 500 while internally to the cylinder 125, air flows from first intake valve 530 to second exhaust valve 520. Compressed air pressure in the high pressure tank 500 is therefore raised storing energy therein.

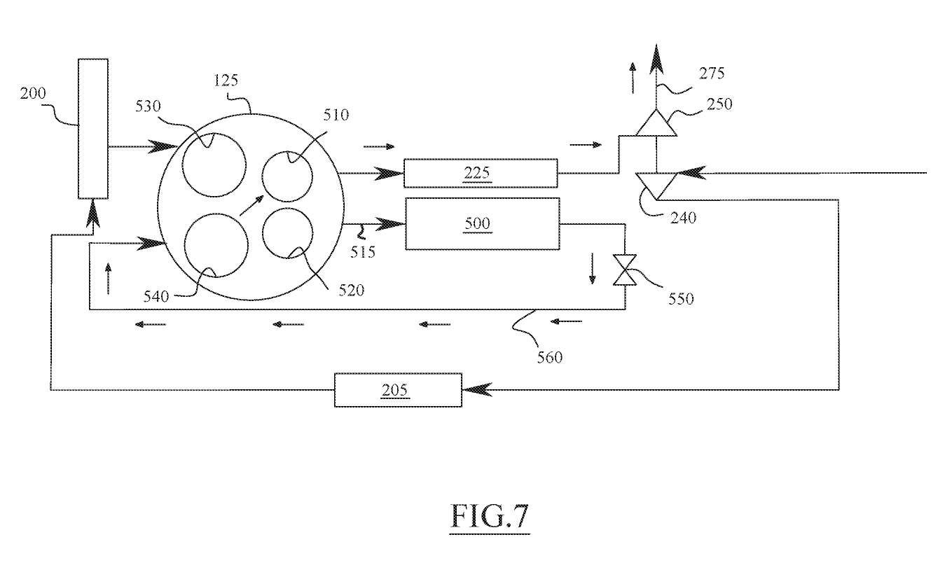

Then, as depicted in FIG. 7, when compressed air pressure in the high pressure tank 500 reaches a predetermined threshold, valve 550 is opened and compressed air flows into the dedicate branch 560 of the pressurized air circuit and from there flows into the cylinder 125 which is then operated as a pneumatic motor. Internally to the cylinder 125, air flows from second intake valve 540 to first exhaust valve 510.

In this way, the internal combustion engine 110 may be operated either in an ICE configuration or in an Energy Recovery mode or in a Pneumatic motor mode, as summarized in the following Table 2:

TABLE 2

| ICE Configuration | Energy Recovery | Pneumatic Motor |
|---|---|---|
| 1^{st} exh. valve 510 active | 1^{st} exh. valve 510 closed | 1^{st} exh. valve 510 |
| | | active |
| 2^{nd} exh. valve 520 closed | 2^{nd} exh. valve 520 active | 2^{nd} exh. valve 520 |
| | | closed |
| 1^{st} int. valve 530 active | 1^{st} int. valve 530 active | 1^{st} int. valve 530 |
| | | closed |
| 2^{nd} int. valve 540 closed | 2^{nd} int. valve 540 closed | 2^{nd} int. valve 540 |
| | | active |

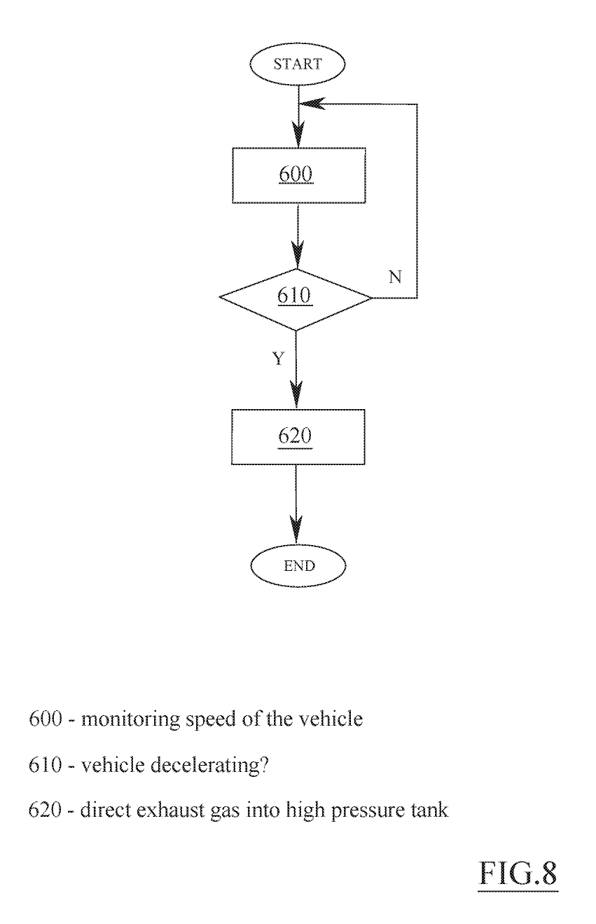

FIG. 8 is a flowchart representing an embodiment of the present disclosure. In such embodiment, the vehicle speed is monitored (block 600). If a deceleration of the vehicle 105 is detected (block 610), an exhaust valve 520 of the cylinder 125 is activated to direct compressed air into a high pressure tank 500 fluidically connected to the cylinder 125 (block 620). In a general fashion, only one of the cylinders 125 of the engine 110 may be configured according to the various embodiments of the present disclosure depicted in FIGS. 3-7, or some or all of the cylinders 125 may configured as such.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the invention as set forth in the appended claims and their legal equivalents.

1-15. (canceled)

16. A method of operating an automotive system for powering a vehicle, the automotive system including an internal combustion engine equipped with at least one cylinder having an exhaust valve, the method comprising:
detecting a deceleration of the vehicle; and
activating the exhaust valve of at least one cylinder to direct compressed air into a high pressure tank fluidically connected to the cylinder in response to the deceleration.

17. The method according to claim 16, further comprising:
detecting a torque request; and
activating the exhaust valve of at least one cylinder to direct compressed air from the high pressure tank into the cylinder in response to the torque request.

18. The method according to claim 17, further comprising mixing compressed air deriving from the high pressure tank with fuel injected into the cylinder.

19. The method according to claim 17, further comprising directing compressed air from the high pressure tank into an air intake duct flowing into an intake manifold of the internal combustion engine.

20. The method according to claim 17, further comprising directing compressed air from the high pressure tank into the cylinder and bypassing an air intake duct of the internal combustion engine.

21. The method according to claim 17, further comprising directing compressed air from the high pressure tank into the cylinder, when the compressed air pressure inside the high pressure tank is greater than a threshold pressure thereof.

22. The method according to claim 16 further comprising interrupting fuel injection into the cylinder when compressed air is directed from the cylinder into the high pressure tank.

23. The method according to claim 16, further comprising interrupting fuel injection into the cylinder when compressed air is directed from the high pressure tank into the cylinder.

24. A computer program comprising a computer-code suitable, which when executed on an electronic control unit, is configured to operate the exhaust valve according to the method of claim 16.

25. An apparatus for operating an automotive system to power a vehicle (105), the automotive system including an internal combustion engine equipped with cylinders having exhaust valves, the apparatus comprising an electronic control unit configured to detect a deceleration of the vehicle, and activate an exhaust valve of at least one cylinder for directing compressed air into a high pressure tank fluidically connected to the cylinder.

26. The apparatus according to claim 25, further comprising a Variable Valve Actuation (VVA) system, wherein the electronic control unit is further configured to activate the Variable Valve Actuation (VVA) system.

27. The apparatus according to claim 25, further comprising a branch of a pressurized air circuit connecting an outlet of the high pressure tank to an intake valve of the cylinder.

28. An internal combustion engine comprising at least one cylinder having exhaust valves, wherein at least an exhaust valve of the cylinder is fluidically connected with an inlet of a high pressure tank.

29. The internal combustion engine according to claim 28, wherein the high pressure tank is fluidically connected to an air intake duct flowing into an intake manifold of the internal combustion engine.

30. The internal combustion engine according to claim 28, wherein the high pressure tank is fluidically connected to an inlet valve of the engine.
